(19) United States
(12) Patent Application Publication
(10) Pub. No.: US 2011/0156857 A1
(43) Pub. Date: Jun. 30, 2011

(54) SILICON-BASED SEMICONDUCTOR DEVICE COMPRISING eFUSES FORMED BY AN EMBEDDED SEMICONDUCTOR ALLOY

(76) Inventors: Andreas Kurz, Dresden (DE); Stephan Kronholz, Dresden (DE); Roman Boschke, Dresden (DE)

(21) Appl. No.: 12/905,779

(22) Filed: Oct. 15, 2010

(30) Foreign Application Priority Data
Dec. 29, 2009 (DE) 10 2009 055 368.1

(51) Int. Cl. H01H 37/76; H01H 69/02

(52) U.S. Cl. 337/414; 29/623

(57) ABSTRACT

An electronic fuse may receive a silicon/germanium material in the fuse body, which in turn may result in the formation of a metal silicide material of reduced thickness. Consequently, the current density and, thus, the electromigration and heat generation in the metal silicide material may be increased for a given amount of current. Consequently, transistor switches for applying the programming pulse to the electronic fuse may be reduced in size.

### BACKGROUND OF THE INVENTION

1. Field of the Invention

The present disclosure generally relates to the field of fabricating integrated circuits, and, more particularly, to forming electronic fuses for providing device internal programming capabilities in complex integrated circuits.

2. Description of the Related Art

In modern integrated circuits, a very high number of individual circuit elements, such as field effect transistors in the form of CMOS, NMOS, PMOS elements, resistors, capacitors and the like are formed on a single chip area. Typically, feature sizes of these circuit elements are steadily decreasing with the introduction of every new circuit generation, to provide currently available integrated circuits with an improved degree of performance in terms of speed and/or power consumption. A reduction in size of transistors is an important aspect in steadily improving device performance of complex integrated circuits, such as CPUs. The reduction in size is commonly associated with an increased switching speed, thereby enhancing signal processing performance. In addition to the large number of transistor elements, a plurality of passive circuit elements, such as capacitors, resistors and the like, are typically formed in integrated circuits that are used for a plurality of purposes.

Due to the decreased dimensions of circuit elements, not only the performance of the individual transistor elements may be improved, but also their packing density may be increased, thereby providing the potential for incorporating increased functionality into a given chip area. For this reason, highly complex circuits have been developed, which may include different types of circuits, such as analog circuits, digital circuits and the like, thereby providing entire systems on a single chip (SoC). Furthermore, in sophisticated microcontroller devices, an increasing amount of storage capacity may be provided on chip with the CPU core, thereby also significantly enhancing the overall performance of modern computer devices.

In such modern integrated circuits, minimal features sizes have now reached approximately 50 nm and less, thereby providing the possibility of incorporating various functional circuit portions at a given chip area, wherein, however, the various circuit portions may have a significantly different performance, for instance with respect to lifetime, reliability and the like. For example, the operating speed of a digital circuit portion, such as a CPU core and the like, may depend on the configuration of the individual transistor elements and also on the characteristics of the metallization system, which may include a plurality of stacked metallization layers so as to comply with a required complex circuit layout. Thus, highly sophisticated manufacturing techniques may be required in order to provide the minimum critical feature sizes of the speed-critical circuit components. For example, sophisticated digital circuitry may be used on the basis of field effect transistors which represent circuit components in which the conductivity of a channel region is controlled on the basis of a gate electrode that is separated from the channel region by a thin dielectric material. Performance of the individual field effect transistor is determined by, among other things, the capability of the transistor to switch from a high impedance state into a low impedance state at high speeds, wherein a sufficiently high current may also have to be driven in the low impedance state. This drive current capability is determined by, among other things, the length of the conductive channel that forms in the channel region upon application of an appropriate control voltage to the gate electrode. For this reason, and in view of the demand for ever increasing the overall packing density of sophisticated semiconductor devices, the channel length, and thus the length of the gate electrode, is continuously being reduced, which, in turn, may require an appropriate adaptation of the capacitive coupling of the gate electrode to the channel region. Consequently, the thickness of the gate dielectric material also may have to be reduced in order to maintain controllability of the conductive channel at a desired high level. However, the shrinkage of the gate dielectric thickness may be associated with an exponential increase of the leakage currents, which may directly tunnel through the thin gate dielectric material, thereby contributing to enhanced power consumption and thus waste heat, which may contribute to sophisticated conditions during operation of the semiconductor device. Moreover, charge carriers may be injected into the gate dielectric material and may also contribute to a significant degradation of transistor characteristics, such as threshold voltage of the transistors, thereby also contributing to variability of the transistor characteristics over the lifetime of the product. Consequently, reliability and performance of certain sophisticated circuit portions may be determined by material characteristics and process techniques for forming highly sophisticated circuit elements, while other circuit portions may include less critical devices which may thus provide a different behavior over the lifetime compared to critical circuit portions. Consequently, the combination of the various circuit portions in a single semiconductor device may result in a significant different behavior with respect to performance and reliability, wherein the variations of the overall manufacturing process flow may also contribute to a further discrepancy between the various circuit portions. For these reasons, in complex integrated circuits, frequently, additional mechanisms may be implemented to allow the circuit itself to adapt performance of certain circuit portions to comply with performance of other circuit portions, for instance upon completing the manufacturing process and/or during use of the semiconductor device, for instance when certain critical circuit portions may no longer comply with corresponding performance criteria, thereby requiring an adaptation of certain circuit portions, such as re-adjusting an internal voltage supply, resetting overall circuit speed and the like.

For this purpose, so-called electronic fuses or e-fuses may be provided in the semiconductor devices, which may represent electronic switches that may be activated once in order to provide a desired circuit adaptation. Hence, the electronic fuses may be considered as having a high impedance state, which may typically also represent a “programmed” state, and may have a low impedance state, typically representing a non-programmed state of the electronic fuse. Since these electronic fuses may have a significant influence on the overall behavior of the entire integrated circuit, a reliable detection of the non-programmed and the programmed state may have to be guaranteed, which may have to be accomplished on the basis of appropriately designed logic circuitry. Furthermore, since typically these electronic fuses may be actuated once over the lifetime of the semiconductor device under consideration, a corresponding programming activity may have to ensure that a desired programmed state of the electronic fuse is reliably generated in order to provide well-defined conditions for the further operational lifetime of the device. However, with the continuous shrinkage of critical device dimensions in sophisticated semiconductor devices, the reliability of the programming of corresponding electronic fuses may require tightly set margins for the corresponding voltages used to program the electronic fuses, which may not be compatible with the overall specifications of the semiconductor devices or may at least have a severe influence on the flexibility of operating the device.

With reference to FIGS. 1a-1b, a typical electronic fuse in a sophisticated semiconductor device will now be described in order to more clearly set forth the difficulties in providing electronic fuses in advanced semiconductor devices.

FIG. 1a schematically illustrates a top view of a portion of a semiconductor device 150 which may represent any semiconductor device including sophisticated digital circuitry, such as a CPU core, a controller for graphic applications, memory areas and the like. The semiconductor device 150 may thus comprise a circuit portion 160, which may include a sophisticated transistor element, such as a field effect transistor having a gate length of 50 nm and less, as previously discussed. Furthermore, the device 150 comprises an electronic fuse 100 that may represent a one-time programmable electronic switch, which may be switched from a low impedance state into a high impedance state upon a current pulse generated by applying an appropriate programming voltage to the electronic fuse 100. As illustrated, the fuse 100 comprises a first contact area 101 and a second contact area 102, also referred to as fuse heads, and an intermediate region 103 or fuse body, provided in the form of a conductive line, which represents the actual fuse element which may alter its impedance state upon connecting the contact areas 101 and 102 with an appropriate voltage source. In some conventional approaches, the contact areas 101, 102 and the conductive line 103 are formed of an appropriate electrode material, which may also be used for forming corresponding gate electrode structures of field effect transistors, provided in the portion 160. For example, polysilicon in combination with a metal silicide are frequently used materials for forming the electronic fuse 100. Frequently, providing the fuses on the basis of a configuration as used for gate electrodes may not be compatible with the requirements to be met by the fuses. For example, the superior conductivity of sophisticated gate electrodes may result in a reduced resistivity of the fuse material, thereby requiring significant design changes and/or additional process steps in order to adapt the resistivity of the fuse material to the required value.

In this case, silicon-on-insulator (SOI) devices allow an efficient alternative to form fuses in the “active” silicon layer, since the active layer is “vertically” isolated by the buried insulating material. Thus, by appropriately defining an “active” region for the fuse 100 within the silicon material of the active layer, the well-known characteristics of the silicon material allow appropriately adjusting the behavior, i.e., the amount of current required for “blowing” the fuse.

As illustrated, each of the contact areas 101, 102 may be connected to corresponding contact elements 121 that are formed in a contact level of the device 150, as will be described in more detail with reference to FIG. 1b.

FIG. 1b schematically illustrates a cross-sectional view of the device 150 along the line Ib of FIG. 1a. As illustrated, the device 150 comprises a substrate 151, such as a silicon substrate and the like, above which is formed a silicon-based semiconductor layer 153, in which an isolation structure 153C laterally delineates semiconductor regions 153A, 153B within the silicon layer 153. Moreover, in the example shown, the semiconductor device 150 represents an SOI configuration, wherein a buried insulating material layer 152, such as a silicon dioxide layer, is formed between the substrate 151 and the semiconductor layer 153. As discussed above, typically, electronic fusers may be formed above an isolation structure, such as the structure 153C, based on an electrode material that is also typically used for forming gate electrode structures of circuit elements, such as a transistor 161, which may represent a circuit element of the circuit portion 160, for instance in the form of a field effect transistor. As discussed above, the gate electrode structure 162 of the transistor 161 may have a moderately high conductivity and, thus, corresponding electronic fuses may have to be formed with an increased length and/or with reduced lateral dimensions in order to enable reliable programming of the electronic fuses, which may, thus, require high current pulses. Consequently, in some approaches, the electronic fuse 100 may be formed within the semiconductor layer 153, i.e., in the example shown, in the active region 153A. Consequently, the fuse body 103 and the contact areas 101, 102 are formed in the semiconductor region 153A and have an appropriate lateral dimension, i.e., a length 103L and a width (in FIG. 1a, the vertical extension of the fuse body 103), so as to provide a desired low impedance state, which may, upon application of a current pulse, change into a high impedance state. Moreover, in the manufacturing stage shown, a metal silicide material 104 is formed in the semiconductor region 153A and, thus, in or on the contact areas 101, 102 and the fuse body 103. Similarly, a metal silicide 164 may be formed in drain and source regions 163 of the transistor 161. The metal silicide materials 104, 164 may be provided in the form of a nickel silicide, a cobalt silicide and the like. Moreover, a contact level 120 is formed above the semiconductor layer 153 so as to enclose the electronic fuse 100 and other circuit elements of the circuit portion 160, such as the transistor 161. Typically, the contact level 120 comprises one or more different dielectric materials, as indicated by 122 and 123, such as silicon nitride and silicon dioxide, respectively, in which are formed the contact elements 121 comprising a highly conductive material, such as tungsten and the like, possibly in combination with any appropriate barrier material, if required.

The semiconductor device 150 may be formed on the basis of any well-established process techniques. For instance, the isolation structure 153C is provided by forming a trench in the semiconductor layer 153, for instance extending down to the buried insulating material 152, and refilling the trench with an appropriate dielectric material, thereby defining the lateral position, size and shape of the semiconductor regions 153A, 153B in accordance with overall design rules. Thereafter, the gate electrode structures of circuit elements, such as the transistor 161, may be formed in accordance with sophisticated deposition, lithography and patterning strategies, wherein critical feature sizes, such as a gate length of 50 nm and less, may have to be applied. Next, the drain and source regions 163 may be formed by using implantation techniques, wherein, typically, implantation into the region 153A may be avoided or may be performed on an appropriate masking regime, depending on the desired basic resistivity of the semiconductor material in the region 153A. After any high temperature processes, for instance for activating the dopant species and the like, the metal silicide materials 104, 164 are formed, for instance by depositing any appropriate refractory metal, such as nickel and the like, and initiating the interdiffusion of the metal species and the silicon material, thereby forming a metal silicide. Consequently, the material characteristics and the thickness of the metal silicides 104, 164 are substantially determined by the basic initial materials of the semiconductor regions 153A, 153B, the refractory metal used and the specific process conditions. It should be appreciated that forming the metal silicide 104 in the electronic fuse 100 is advantageous for the operational behavior of the fuse 100, since the metal silicide material 104 may be efficiently used for causing electromigration upon programming the fuse 100, as will be described later on in more detail.

Next, the contact level 120 is formed by depositing the materials 122 and 123 and patterning these materials in order to form openings, which may subsequently be filled with any appropriate conductive material. After the removal of any excess material, the contact elements 121 are obtained, which connect to the contact areas 101, 102 of the electronic fuse 100, while other contact elements (not shown) may connect to any circuit elements in the circuit portion 160 in accordance with the overall layout of the circuit under consideration. Moreover, a metallization system (not shown) is typically formed above the contact level 120 in order to provide a complex interconnect network for connecting the individual circuit components, for instance for connecting the electronic fuse 100 to an appropriate control circuitry and to transistors for providing a current pulse upon programming the electronic fuse 100.

Upon operating the device 150 and programming the electronic fuse 100, a sufficiently high voltage is to be applied between the contact areas 101 and 102 in order to generate a sufficiently high current density in the fuse body 103, which may result in a permanent modification of the electronic characteristics of the fuse body 103 in order to “blow” the fuse 100. For example, in this case the per se negative effect of electromigration may be advantageously used to induce a current-driven material diffusion in the fuse body 103, that is, in the metal silicide region 104 thereof, which may result in a significant modification of the electrical performance. That is, a corresponding high impedance state is achieved due to the “degradation” of the fuse body 103. Electromigration is a well-known effect, which occurs in conductive lines, typically metal-containing lines, when the current density is very high so that the flow of electrons may cause a directed “diffusion” of the ion caused by momentum transfer, thereby increasingly displacing material along the electron flow direction. Thus, the corresponding line may increasingly suffer from a depletion of material in the vicinity of the cathode, while material may be accumulated at or next to the line in the vicinity of the anode of the corresponding conductive line. In the electronic fuse 100, the electromigration may preferably take place in the metal silicide material 104 of the fuse body 103, which may have appropriate lateral dimensions so as to achieve the desired high current density. As previously discussed, a reliable distinction between a non-programmed state and a programmed state requires a corresponding significant modification of the fuse body 103, which in turn requires a sufficiently high current that has to be driven through the fuse body 103 in order to achieve the desired electromigration effect and, thus, the desired degradation of the fuse body 103, which results in a significantly higher resistance. Consequently, appropriately sized transistor elements as switches for supplying the high current to the electronic fuse 100 have to be provided with a sufficiently high current drive capability and may also have to withstand the supply voltages that are required for creating the high current pulses. In conventional strategies, the length of the fuse bodies is increased and/or the width thereof is reduced in an attempt to reduce the required amount of current for inducing the desired electromigration effect in the fuse bodies, so as to enable a reduction in size of the associated drive transistor elements. For example, the contact areas 101, 102, also referred to as fuse heads, may also be reduced in size in order to efficiently use this area as a part of the electromigration area of the electronic fuse, which may, however, impose restrictions upon forming the contact elements 121, since these elements may, nevertheless, have to provide the required current density. Thus, any irregularity upon forming the electronic fuse 100 and/or the contact elements 121 may result in a significant variation of the required voltage values and current densities for programming the electronic fuse 100, which may not be compatible with the tightly set process tolerances in sophisticated semiconductor devices.

The present disclosure is directed to various methods and devices that may avoid, or at least reduce, the effects of one or more of the problems identified above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the present disclosure provides semiconductor devices and methods for forming the same, in which the electronic fuses may be provided so as to enable the programming of electronic fuses with reduced currents without negatively affecting the reliability of the programming process. To this end, the amount of metal silicide material may be reduced, at least in the fuse body of an electronic fuse, so that a higher current density, in combination with an increased resistivity, may be achieved in the metal silicide material for a given desired magnitude of current. In some illustrative aspects disclosed herein, a reduced amount of metal silicide, for instance a reduced thickness of a metal silicide layer in the fuse body, possibly in combination with a reduced thickness in the contact areas, may be achieved by replacing a portion of the initial silicon-based semiconductor material with a semiconductor material having a reduced silicidation rate, thereby reducing the degree of interdiffusion during the silicidation process. Consequently, the resulting metal silicide material may have a reduced thickness, which in turn may lead to a more pronounced electromigration effect for a given amount of current. Hence, corresponding peripheral components, such as transistors for supplying the voltage and current for the programming of the electronic fuses, may be reduced in size, which in turn may allow a generally increased packing density of complex semiconductor devices.

One illustrative method disclosed herein relates to forming an electronic fuse of a semiconductor device. The method comprises forming an isolation structure in a semiconductor layer so as to laterally delineate a fuse region in the semiconductor layer. The method further comprises forming a metal silicide material in the fuse region, wherein the metal silicide material has a first thickness in a contact area of the electronic fuse and has a second thickness in a fuse body of the electronic fuse and wherein the second thickness is less than the first thickness.

A further illustrative method relates to forming an electronic fuse of a semiconductor device. The method comprises replacing at least a portion of a semiconductor material of a fuse region with a semiconductor mixture that has a silicidation rate that is less than a silicidation rate of the at least a portion of the semiconductor material. The method further comprises forming a metal silicide material in the semiconductor mixture and forming contact elements in an interlayer dielectric material so as to connect to contact areas formed in the fuse region.

One illustrative semiconductor device disclosed herein comprises a circuit element formed in and above a first semiconductor region of a semiconductor layer. The semiconductor device further comprises an electronic fuse formed in a second semiconductor region of the semiconductor layer. The electronic fuse comprises a first contact area, a second contact area and a fuse body formed in the second semiconductor region. At least the fuse body comprises a first silicon-containing material having a first silicidation rate with respect to a predefined silicidation recipe. Furthermore, the fuse body comprises a second silicon-containing material formed above the first silicon-containing material and having a second silicidation rate that is less than the first silicidation rate. Additionally, the electronic fuse comprises a metal silicide formed in the first and the second contact areas and the fuse body according to the predefined silicidation recipe.

### BRIEF DESCRIPTION OF THE DRAWINGS

The disclosure may be understood by reference to the following description taken in conjunction with the accompanying drawings, in which like reference numerals identify like elements, and in which:

FIG. 1a schematically illustrates a top view of a conventional semiconductor device comprising an electronic fuse;

FIG. 1b schematically illustrates a cross-sectional view of the conventional device of FIG. 1a;

FIGS. 2a-2e schematically illustrate cross-sectional views of a semiconductor device during various manufacturing stages in forming an electronic fuse on the basis of a semiconductor alloy having a reduced silicidation rate compared to a silicon material, according to illustrative embodiments;

FIGS. 2f-2g schematically illustrate top views of some examples of an electronic fuse, according to illustrative embodiments;

FIG. 2h schematically illustrates a cross-sectional view of the semiconductor device, wherein a silicon/germanium alloy may be provided in an electronic fuse and in transistor elements, according to further illustrative embodiments;

FIG. 2i schematically illustrates a cross-sectional view of the semiconductor device, in which a metal silicide of reduced thickness may be formed along the entire length of an electronic fuse, according to still further illustrative embodiments; and

FIG. 2j schematically illustrates a cross-sectional view of the semiconductor device, wherein modifying the silicidation behavior of at least a portion of an electronic fuse is based on an implantation process, according to still further illustrative embodiments.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the present disclosure provides semiconductor devices and manufacturing techniques in which electronic fuses may receive a reduced amount of metal silicide in order to initiate a sufficient electromigration effect on the basis of a reduced overall current compared to conventional strategies. For this purpose, in some illustrative embodiments disclosed herein, at least the fuse body may be formed on the basis of a semiconductor material that has a reduced silicidation rate, thereby obtaining a reduced thickness of the metal silicide in the fuse body, which in turn may result in an increased current density and in an increased temperature of the fuse body upon applying a given current to the electronic fuse. For this purpose, a portion of the initial silicon-based material may be replaced with a semiconductor material that has a reduced silicidation rate, such as a silicon/germanium mixture, thereby efficiently reducing the amount of metal silicide that is formed in the electronic fuse during a silicidation process. In some illustrative embodiments disclosed herein, the electronic fuse may be formed in the semiconductor layer of an SOI device, thereby achieving a high degree of compatibility with a conventional process strategy in forming circuit elements, such as field effect transistors, which may also require a metal silicide material in the drain and source regions. On the other hand, the process for forming the electronic fuses may be efficiently decoupled from any process specifics for forming sophisticated gate electrode structures, thereby providing electronic fuses that can be programmed with reduced supply voltages and drive currents in a reliable manner without being affected by the configuration of gate electrode structures, such as high-k metal gate electrode structures and the like. By efficiently reducing the amount of metal silicide material, at least in the fuse body of an electronic fuse, a pronounced electromigration effect may be achieved on the basis of a reduced total current, which may, nevertheless, result in a sufficient current density within the metal silicide region in order to achieve the desired modification of the electronic behavior of the fuse. Furthermore, the reduced amount of metal silicide, at least in the fuse body, may result in an increased resistance, which in turn may cause a more pronounced rise of the local temperature upon driving a current through the fuse body, thereby also contributing to a more efficient programming behavior.

In some illustrative embodiments, the incorporation of silicon-containing semiconductor material having a reduced silicidation rate, at least in the fuse body, may be advantageously combined with the provision of a strain inducing semiconductor material in sophisticated transistor elements, thereby substantially avoiding any additional process steps for endowing the electronic fuses with a superior sensitivity during the programming process. In other illustrative embodiments, the silicidation behavior of at least the fuse body may be efficiently modified by incorporating any appropriate species, such as oxygen, nitrogen and the like, which may efficiently reduce the interdiffusion of the metal species and the silicon species during the silicidation process. Consequently, efficient electronic fuses may also be incorporated into semiconductor devices, which may not require additional strain-inducing semiconductor alloys, for instance in low power devices and the like, while at the same time avoiding additional selective epitaxial growth processes.

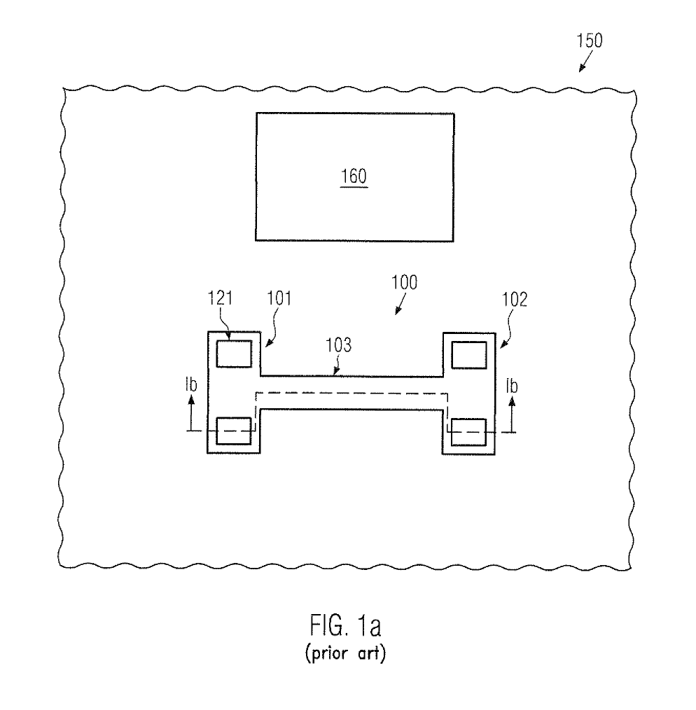

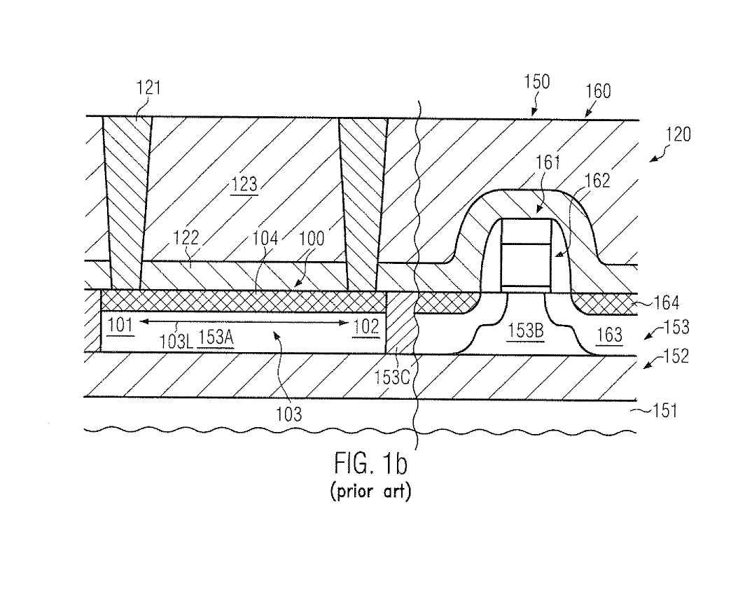

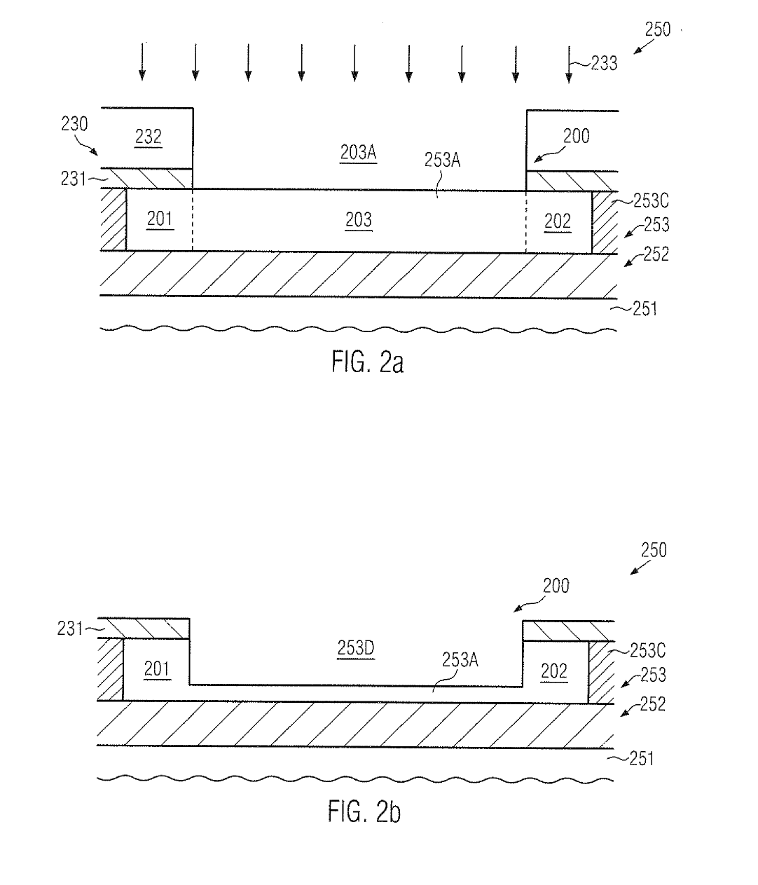

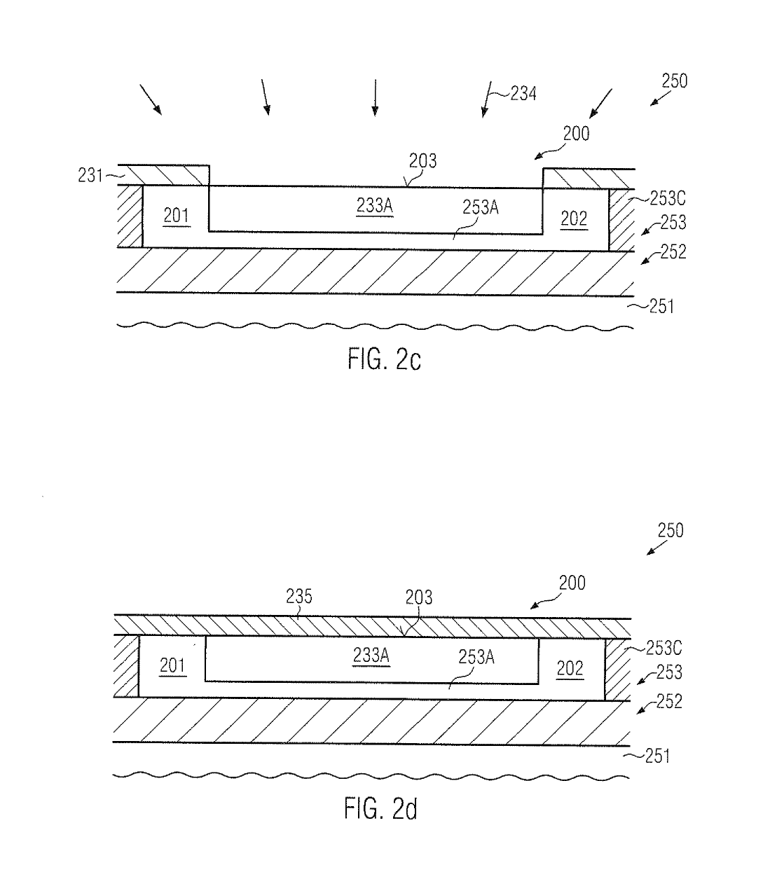

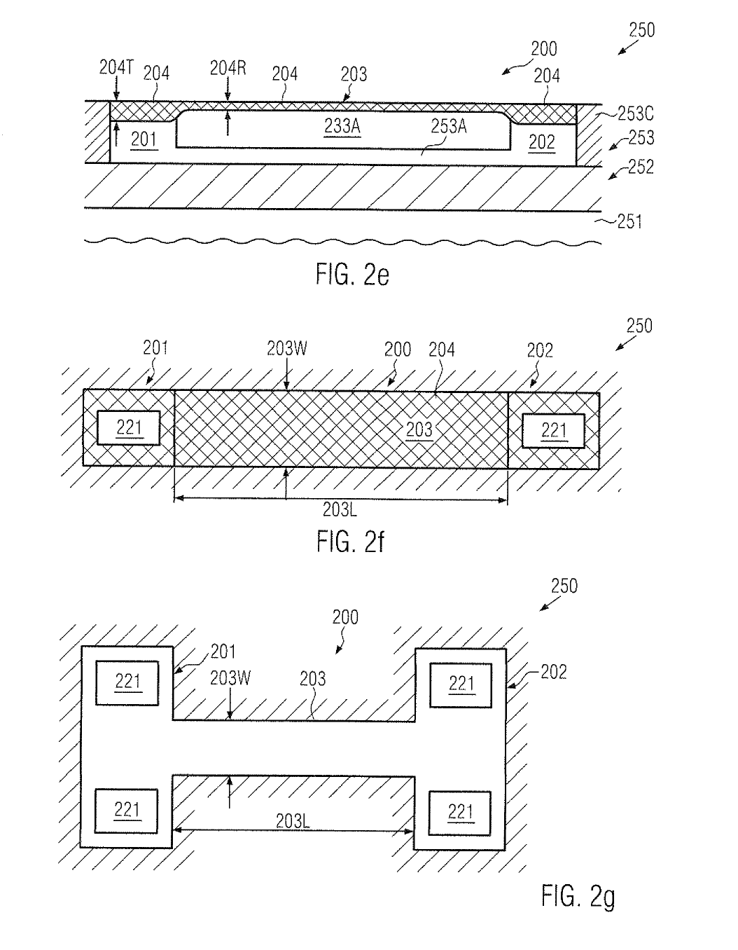

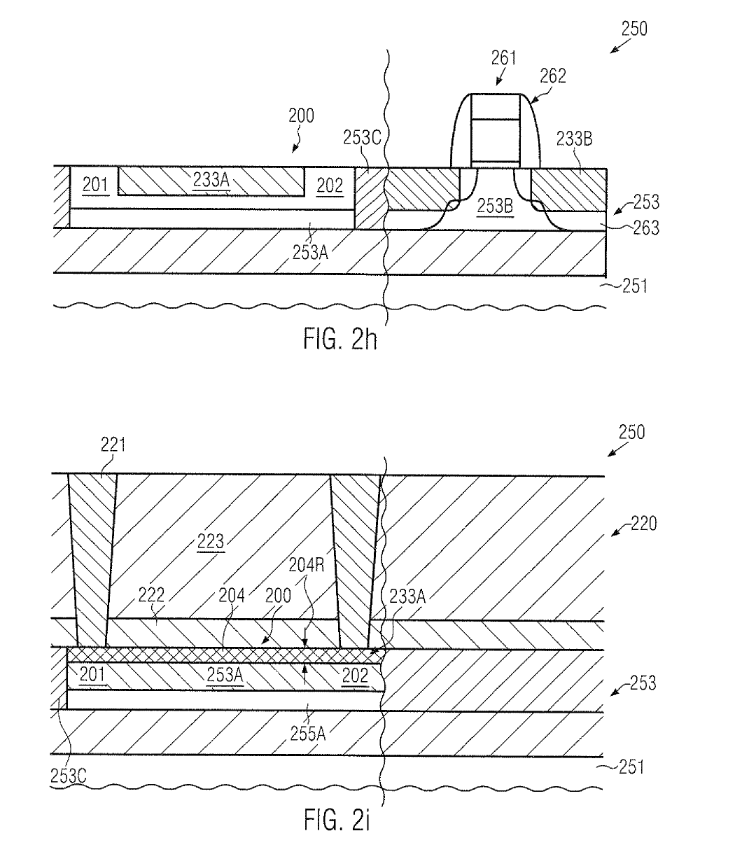

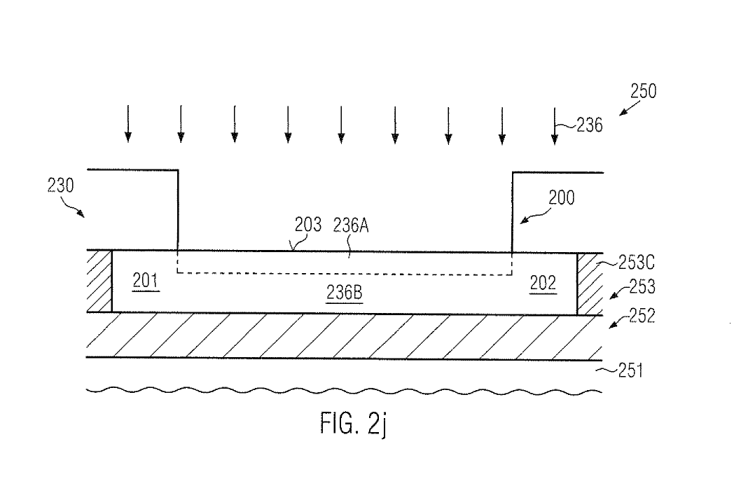

With reference to FIGS. 2a-2j, further illustrative embodiments will now be described in more detail, wherein reference may also be made to FIGS. 1a-1b, if required.

FIG. 2a schematically illustrates a cross-sectional view of a semiconductor device 250 comprising a substrate 251, above which may be formed a silicon-based semiconductor layer 253, in which an isolation structure 253C, such as a shallow trench isolation, may laterally delineate a semiconductor region 253A. Furthermore, in the embodiment shown, a buried insulating layer 252 may be provided between a substrate 251 and the semiconductor layer 253, thereby forming an SOI configuration. The semiconductor region 253A may represent the basic semiconductor material for forming therein an electronic fuse 200, which may comprise a first contact area 201 and a second contact area 202, having any appropriate lateral size and shape for being contacted by corresponding contact elements or by directly connecting to a circuit element, such as a transistor (not shown), in accordance with the overall layout of respective peripheral circuitry for connecting to the electronic fuse 200. The contact areas 201, 202, may laterally enclose a fuse body 203, which in turn may have any appropriate configuration, i.e., a required length, i.e., in FIG. 2a, the horizontal extension of the fuse body 203, and a width, i.e., a direction perpendicular to the drawing plane of FIG. 2a, in order to obtain a desired low impedance state and high impedance state, as required for defining two reliably distinguishable states of the electronic fuse 200, as is also previously discussed. Consequently, the semiconductor region 253A, which may also be referred to as a fuse region, may have any appropriate lateral size and shape so as to accommodate the contact areas 201, 202 and the fuse body 203, which may electrically connect the contact areas 201, 202 and which may represent an area in which an electromigration effect is to be reliably initiated upon programming the electronic fuse 200. In the manufacturing stage shown, a mask 230, which may comprise one or more hard mask materials 231, such as silicon nitride and the like, possibly in combination with a resist material 232, may be formed above the semiconductor layer 253 and may have an appropriate opening 203A, which may, thus, define the lateral position and size of the fuse body 203.

It should be appreciated that, as discussed above or as will be discussed later on in more detail, the semiconductor layer 253 may comprise other semiconductor regions, in which circuit elements, such as transistors and the like are formed or are to be formed, depending on the overall process strategy.

The semiconductor device 250 may be formed on the basis of the following processes. The isolation structure 253C in the semiconductor layer 253 may be formed on the basis of well-established process techniques by using appropriate lithography masks to define the semiconductor region or fuse region 253A having the desired lateral size and shape in order to obtain, in combination with a reduced amount of metal silicide to be provided at least in the fuse body 203, a desired low impedance state and, upon programming the electronic fuse 200, a desired high impedance state. It should be appreciated that other semiconductor regions for transistors and the like may also be formed together with the fuse region 253A in other device areas. In some illustrative embodiments, the further processing may be continued by forming circuit elements or portions thereof, for instance, such as gate electrode structures of transistors, as required. Thereafter, the further processing may be continued by providing the mask 230, for instance by depositing an appropriate material, such as silicon nitride in the form of the layer 231, and forming the material 232, such as a resist material, which may be accomplished by well-established lithography techniques. The material layer 231 may be patterned in accordance with well-established etch techniques using the mask 232, which may also be used during a further etch process 233 that is configured to remove material of the semiconductor region 253A. For example, a plurality of anisotropic etch recipes for removing silicon material are well established in the art and may be used during the process 233. During the etch process 233, material 232 and/or the material 231 may act as an efficient etch stop material so as to protect the contact areas 201, 202.

FIG. 2b schematically illustrates the semiconductor device 250 in a further advanced manufacturing stage, in which a cavity 253D may be formed in the semiconductor region 253A and may extend to an appropriate depth, thereby, in the embodiment shown, preserving a portion of the initial material of the region 253A at the bottom of the cavity 253D. It should be appreciated that cavities may also be formed in other semiconductor regions, for instance in active regions of transistor elements, when these transistors may require the incorporation of an appropriate semiconductor material, such as a strain-inducing semiconductor material and the like. In this case, the process parameters of the etch process 233 of FIG. 2a may be appropriately selected so as to comply with the requirements for forming the corresponding cavities in these active regions of the transistors. Thereafter, the semiconductor device 250 may be prepared for the deposition of an appropriate semiconductor material, for instance on the basis of selective epitaxial growth techniques and the like. For this purpose, respective cleaning processes may be performed, as required.

FIG. 2c schematically illustrates the semiconductor device 250 in a further advanced manufacturing stage, in which a semiconductor material 233A may be formed above the remaining material of the semiconductor region 253A in order to refill the previously formed cavity 253D (FIG. 2b). For this purpose, in the embodiment shown, a deposition process 234, such as a selective epitaxial growth process, may be performed, in which the layer 231 may act as an efficient deposition mask, possibly in combination with the isolation structure 253C. By using an epitaxial growth process, the material 233A may be provided in the form of a crystalline material, which, for instance, may be provided in a strained state, which may be advantageous for enhancing performance of transistor elements and the like. For example, in some illustrative embodiments, the semiconductor material 233A may be provided in the form of a silicon/germanium mixture with germanium contents of approximately 15-35 atomic percent, thereby obtaining a significantly different behavior during a silicidation process to be performed in a later manufacturing stage. It is well known that a silicon/germanium material in polycrystalline or crystalline form may have a reduced tendency for forming a metal silicide, which may, thus, result in a reduced amount of metal silicide material formed in the semiconductor material 233A compared to the initial semiconductor material of the semiconductor layer 253, for instance in the contact areas 201, 202. It should be appreciated that, in other illustrative embodiments, other semiconductor materials may be used, if compatible with the overall device requirements. For example, in some cases, a silicon/tin/germanium mixture may be formed, when such a material composition may be considered advantageous for inducing a desired high compressive strain component in the active regions of P-channel transistors.

After deposition of the material 233A, the further processing may be continued, for instance, by performing implantation sequences and the like for forming drain and source regions in transistor elements, while the electronic fuse 200 may be masked so as to avoid undue incorporation of dopant species, when considered inappropriate for the overall electronic characteristics of the electronic fuse 200. It should be appreciated, however, that a desired dopant species and concentration may be incorporated into the electronic fuse 200 as required for achieving the target resistance of the electronic fuse 200. After any high temperature processes for activating dopants and reducing implantation-induced damage, a silicidation process may be performed.

FIG. 2d schematically illustrates the device 250 with a layer of refractory metal 235 formed above the semiconductor region 253A, which comprises the semiconductor material 233A having the reduced silicidation rate. It should be appreciated that the layer 235 may be comprised of any appropriate metal, such as nickel, cobalt, platinum and the like, as is required for increasing conductivity of doped semiconductor areas, such as drain and source regions of transistor elements. Thereafter, any appropriate heat treatment or sequence of heat treatments may be performed so as to initiate the diffusion of the metal material in the layer 235 into the underlying semiconductor material, i.e., into the contact areas 201, 202, and into the material 233A, wherein the diffusion activity of the metal layer 235 in the material 233A may be reduced. Consequently, an increased amount of silicon per unit volume may be consumed in the contact areas 201, 202 compared to the semiconductor material 233A of the fuse region 203. Thus, after the chemical reaction between the metal species in the layer 235 and the underlying semiconductor material, an increased amount of metal silicide per unit area may be obtained in the contact areas 201, 202, compared to the fuse body 203. Thereafter, any excess material of the layer 235 may be removed on the basis of any well-established reactive etch recipes, and, thereafter, if required, any further heat treatment may be performed so as to thermally stabilize a metal silicide material.

FIG. 2e schematically illustrates the semiconductor device 250 with a metal silicide material 204 formed in the contact areas 201, 202, and in the fuse body 203, wherein a thickness 204R of the metal silicide material 204 in the fuse body 203 may be less compared to a thickness 204T in the contact areas 201, 202, due to the difference in the diffusion behavior caused by the different material composition of the material of the layers 253 and 233A. Consequently, the electrical resistance of the fuse body 203 may be increased compared to the resistivity of the contact areas 201, 202 due to the reduced thickness 204R compared to the thickness 204T, since the overall resistance of the electronic fuse 200 may be substantially determined by the metal silicide material 204 rather than by the remaining semiconductor portions in the contact areas 201, 202 and the fuse body 203.

Consequently, upon operating the semiconductor device 250 for a given current driven through the electronic fuse 200, the current density in metal silicide region 204 having the reduced thickness 204R in the fuse body 203 may be significantly greater compared to the current density in the contact areas 201, 202, even if these areas may have the same width, that is, the same lateral dimension in a direction perpendicular to the drawing plane of FIG. 2e, as the fuse body 203. Consequently, the fuse body 203 represents the area in which, preferably, significant electromigration may occur for a given current, thereby reliably creating the electromigration effect for “degrading” the fuse body 203 and, thus, significantly increasing the resistivity thereof. Consequently, the size of any transistor elements, required for controllably supplying a current pulse to the electronic fuse 200, may be reduced, since the increased electromigration effect in the fuse body 203, in combination with the generally increased lateral resistance, which in turn results in an increased local temperature upon programming the electronic fuse 200, may result in a reliable and permanent modification of the electronic fuse 200 at generally reduced currents compared to conventional electronic fuses, as previously described with reference to the device 100. The further processing of the device 250 may be continued by forming a contact level, as is also previously described with reference to the device 100, and providing appropriate contact elements therein so as to connect to one or both of the contact areas 201, 202.

FIG. 2f schematically illustrates the electronic fuse 200 according to illustrative embodiments in which the electronic fuse 200 may comprise the contact areas 201, 202 with substantially the same width 203W as the fuse body 203. Due to the different thickness of the metal silicide material 204 in these areas, desired increased current drive capabilities of the contact areas 201, 202 may, nevertheless, be provided, while the fuse body 203 may provide the desired high electromigration effect. Consequently, the contact areas 201, 202 may be contacted by appropriately dimensioned contact elements 221 in a very space-efficient manner.

FIG. 2g schematically illustrates the electronic fuse 200 according to further illustrative embodiments in which the fuse body 203 may have the width 203w, which may be less than the lateral dimension of the contact areas 201, 202 in the width direction, thereby providing pronounced fuse heads for the fuse 200. Furthermore, the length 203L is appropriately selected so as to obtain the desired electromigration effect for a given current density within the fuse body 203. On the other hand, the contact areas 201, 202 may be efficiently contacted by two or more contact elements 221, per contact area, thereby providing superior contact reliability.

It should be appreciated that the electronic fuse 200 may have any appropriate size and shape, for instance, a plurality of linear portions may be provided in the fuse body 203, which may be connected under any desired angle, for instance a plurality of 90 degree angles may be applied, thereby providing the possibility of increasing the length 203L without unduly consuming valuable chip area of the device 200.

FIG. 2h schematically illustrates the semiconductor device 250 according to further illustrative embodiments in which a second semiconductor region 253B may be provided in the semiconductor layer 253 and may comprise drain and source regions 263 of a transistor 261. The transistor 261 may comprise a gate electrode structure 262 having any appropriate configuration. It should be appreciated that the transistor 261 may represent a portion of an electronic circuitry formed in the device 250, as previously explained with reference to the semiconductor device 100. In other cases, the transistor 261 may represent a part of a peripheral circuitry for controlling the program status of the electronic fuse 200. For example, the transistor 261 may represent a transistor for supplying current to the electronic fuse 200 in order to permanently modify the resistance state of the fuse 200, as discussed above. As indicated, since the electronic fuse 200 may be programmed at a reduced current compared to conventional configurations, as previously discussed with reference to the device 100, the drive current capability and, thus, the size of the transistor 261 may be reduced, thereby increasing overall packing density in the semiconductor device 250. In other cases, the transistor 261 may represent any other circuit element, wherein, in the embodiment shown, the transistor 261 may have incorporated in drain and source regions 263 thereof a strain-inducing semiconductor material 233B, which may have the same material composition as the material 233A provided in the electronic fuse 200. For example, the materials 233A, 233B may represent a silicon/germanium material, which may lead to the superior performance of the electronic fuse 200, as discussed above, and which in turn may provide a desired high compressive strain component in the transistor 261, thereby increasing the overall transistor performance, since a compressive strain component may increase charge carrier mobility in the transistor 261. In some illustrative embodiments, the device 250 may be formed on the basis of a process sequence in which the materials 233A and 233B may be incorporated into the active regions 253A, 253B, respectively, by performing a common process sequence. That is, after providing a gate electrode structure 262 of the transistor 261 on the semiconductor region 253B, cavities may be formed in the semiconductor regions 253A, 253B, as is, for instance, previously explained, and thereafter the cavities may be refilled by a selective epitaxial growth process, thereby forming the materials 233A, 233B, respectively. Consequently, the material 233A in the semiconductor region 253A may be provided without requiring any additional process steps, when the material 233B may be required for meeting the performance specifications of the transistor 261.

FIG. 2i schematically illustrates the semiconductor device 250 according to further illustrative embodiments. As illustrated, a contact level 220 may be formed above the semiconductor layer 253 and may comprise any appropriate materials, such as a first material 222 in combination with a second material 223, which may be provided in the form of silicon nitride, silicon dioxide and the like, as is also previously explained with reference to the device 100. Furthermore, contact elements 221 are formed in the device level 220 so as to connect to the contact areas 201 and 202 of the electronic fuse 200. Furthermore, in the embodiment shown, the semiconductor material 233a having the reduced silicidation rate, such as the silicon/germanium alloy and the like, may be formed so as to extend into the contact areas 201, 202 so that the metal silicide 204 may also be provided with the reduced thickness 204R in the contact areas 201, 202. In this case, the effective length of a region for inducing a pronounced electromigration effect may be increased, since a very high current density may already be created in the contact areas 201, 202, thereby providing the possibility of reducing the overall size of the electronic fuse 200. The material 233A may be provided on the basis of process techniques, as described above, wherein the isolation structure 253C may be used as an efficient mask during the above described process sequence.

FIG. 2j schematically illustrates the semiconductor device 250 according to further illustrative embodiments. As illustrated, the mask 230 may be formed above the electronic fuse 200 so as to expose the fuse body 203, while covering the contact areas 201, 202. For example, the mask 230 may be provided in the form of a resist mask and the like. Moreover, the device 250 may be exposed to a process 236 for modifying at least a portion of the initial semiconductor material of the fuse body 203. In this sense, a portion of the fuse body 203 may be “replaced” by a material having a reduced silicidation rate with respect to a specific silicidation recipe that is to be applied in a later manufacturing stage, as is also described above. In one illustrative embodiment, the process 236 may represent an implantation process for incorporating an appropriate species into the fuse body 203, thereby reducing the diffusivity of a metal species in the fuse body 203 during the silicidation process to be performed in a later stage. For example, in some illustrative embodiments, nitrogen may be incorporated into the fuse body 203, for instance with an appropriate implantation energy in order to preserve a potentially non-modified portion 236A, which may, thus, take part in a chemical reaction during a silicidation process, while a deeper portion 236B may substantially suppress any formation of a metal silicide. In other cases, the implantation species may be implemented into the portion 236A, thereby generally reducing the conductivity thereof and also reducing the silicidation rate, while the lower portion 236B may remain substantially non-modified. In this case, upon performing a silicidation process, a significantly reduced amount of metal silicide may be formed in the material 236A due to the presence of the implantation species, such as nitrogen and the like. In other cases, an oxygen species may be incorporated into the fuse body 203 at an appropriate height and a subsequent heat treatment may result in the formation of an embedded silicon dioxide-like material, which may, thus, represent an appropriate barrier for formation of any metal silicide in a later manufacturing stage. Consequently, by appropriately selecting the implantation energy, the modified portion 236A may be provided in such a manner that a target thickness of a metal silicide may be obtained during the further processing.

Based on the modification process 236, a portion of the fuse body 203 may be efficiently “replaced” with a material having a reduced silicidation rate with respect to a specified silicidation recipe, without requiring complex epitaxial growth processes. For example, in low power semiconductor devices, the incorporation of strain-inducing semiconductor alloy in transistor elements may not be required, so that, upon avoiding any additional selective epitaxial growth process, nevertheless, an efficient reduction of the metal silicide material thickness may be accomplished in the fuse body 203 on the basis of the modification process 236, for instance in the form of an implantation process.

As a result, the present disclosure provides semiconductor devices and manufacturing techniques, in which a superior programming behavior may be accomplished in electronic fuses by reducing the amount of metal silicide or the thickness thereof, at least in the fuse body, thereby obtaining a superior heat generation and electromigration for a given amount of current. Thus, the size of peripheral transistor elements connected to the electronic fuse may be reduced. Additionally, the overall size of the electronic fuse may also be reduced, for instance in terms of the length of the electronic fuse, which may also contribute to superior overall packing density.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of forming an electronic fuse of a semiconductor device, the method comprising:
forming an isolation structure in a semiconductor layer so as to laterally delineate a fuse region in said semiconductor layer; and
forming a metal silicide material in said fuse region, said metal silicide material having a first thickness in a contact area of said electronic fuse and having a second thickness in a fuse body of said electronic fuse, said second thickness being less than said first thickness.

2. The method of claim 1, further comprising replacing material of said semiconductor layer, at least in a portion of said fuse body, with a semiconductor material having a reduced silicidation rate relative to said replaced material.

3. The method of claim 2, wherein replacing material of said semiconductor layer, at least in a portion of said fuse body, comprises forming a cavity in said fuse body and regrowing a semiconductor alloy in said cavity.

4. The method of claim 3, wherein said semiconductor alloy is a strain-inducing semiconductor alloy used to replace a portion of active regions of transistors formed in and above said semiconductor layer.

5. The method of claim 3, wherein said semiconductor alloy comprises a crystalline silicon/germanium mixture.

6. The method of claim 1, further comprising incorporating a diffusion blocking species into said fuse body prior to forming said metal silicide material, wherein said diffusion blocking species reduces an interdiffusion of metal and silicon when forming said metal silicide.

7. The method of claim 6, wherein said diffusion blocking species comprises at least one of oxygen and nitrogen.

8. A method of forming an electronic fuse of a semiconductor device, the method comprising:
replacing at least a portion of a semiconductor material of a fuse region with a semiconductor mixture, said semiconductor mixture having a silicidation rate that is less than a silicidation rate of said at least a portion;
forming a metal silicide material in said semiconductor mixture; and
forming contact elements in an interlayer dielectric material so as to connect to contact areas formed in said fuse region.

9. The method of claim 8, wherein replacing at least a portion of a semiconductor material of a fuse region comprises laterally delineating a body region and a first and second contact area in said fuse region and selectively replacing at least a part of said body region with said semiconductor mixture.

10. The method of claim 8, wherein replacing at least a portion of a semiconductor material of a fuse region comprises laterally delineating a body region and a first and second contact area in said fuse region and replacing at least a part of said body region and said first and second contact areas with said semiconductor mixture.

11. The method of claim 8, wherein replacing at least a portion of a semiconductor material of a fuse region comprises forming a cavity in said fuse region so as to preserve said semiconductor material at a bottom of said cavity and refilling said cavity with said semiconductor mixture.

12. The method of claim 8, further comprising forming a transistor in and above a semiconductor region and incorporating said semiconductor mixture into a part of said semiconductor region.

13. The method of claim 12, wherein said semiconductor mixture is formed in said fuse region and in said semiconductor region in a common process sequence.

14. The method of claim 8, wherein said semiconductor mixture comprises a silicon/germanium alloy.

15. The method of claim 8, wherein replacing at least a portion of a semiconductor material of a fuse region with a semiconductor mixture comprises incorporating an implantation species into said at least a portion so as to provide said semiconductor mixture as a compound of said semiconductor material and said implantation species.

16. A semiconductor device, comprising:
a circuit element formed in and above a first semiconductor region of a semiconductor layer; and
an electronic fuse formed in a second semiconductor region of said semiconductor layer, said electronic fuse comprising a first contact area, a second contact area and a fuse body formed in said second semiconductor region, at least said fuse body comprising a first silicon-containing material having a first silicidation rate with respect to a predefined silicidation recipe, said fuse body further comprising a second silicon-containing material formed above said first silicon-containing material and having a second silicidation rate that is less than said first silicidation rate, said electronic fuse further comprising a metal silicide formed in said first and second contact areas and said fuse body according to said predefined silicidation recipe.

17. The semiconductor device of claim 16, wherein a thickness of said metal silicide formed in said fuse body is less than the thickness of said metal silicide formed in said first and second contact areas.

18. The semiconductor device of claim 16, wherein said second semiconductor region is formed on a buried insulating material.

19. The semiconductor device of claim 16, wherein at least said fuse body comprises a crystalline silicon/germanium mixture.

20. The semiconductor device of claim 16, wherein a lateral dimension of said first and second contact regions along a direction perpendicular to a current flow direction in said fuse body is greater than a corresponding lateral dimension of said fuse body.
